(19) United States
(12) Patent Application Publication
(10) Pub. No.: US 2016/0026959 A1
(43) Pub. Date: Jan. 28, 2016

(54) Visual Workflow Display and Management

(71) Applicant: THE BROAD INSTITUTE, INC., Cambridge, MA (US)

(72) Inventor: Zachary H. Leber, Arlington, MA (US)

(21) Appl. No.: 14/771,446

(22) PCT Filed: Mar. 6, 2014
(86) PCT No.: PCT/US14/21225

§ 371 Date: Aug. 28, 2015

Related U.S. Application Data
(60) Provisional application No. 61/775,083, filed on Mar. 8, 2013.
(60) Provisional application No. 61/839,773, filed on Jun. 26, 2013.

(51) Int. Cl. G06Q 10/06; G06T 11/60; G06T 11/20

(52) U.S. Cl. CPC G06Q 10/06316; G06T 11/206; G06T 11/60

(57) ABSTRACT

A computer-implemented method or system of visually displaying a workflow can include visually arranging graphical representations of batches within a workflow to indicate workloads at multiple tasks within the workflow to form a visual arrangement. The graphical representations can have a graphical feature indicating relative workloads to process the batches at the respective tasks. The method further includes updating the visual arrangement of the representations of batches as batches progress within the workflow. The current approach provides the user with a more intuitive feeling of the workload, e.g., the number of samples, at each stage or task in a workflow. This has the benefit that the user can more easily identify any backlogs or bottlenecks in the workflow. Furthermore, embodiments provide the user with ability to selectively re-batch by interacting with the graphical representations of batches.

### RELATED APPLICATIONS

This application claims the benefit of U.S. Provisional Application No. 61/839,773 filed Jun. 26, 2013, and U.S. Provisional Application No. 61/775,083 filed Mar. 8, 2013. The entire teachings of the above applications are incorporated herein by reference.

### BACKGROUND OF THE INVENTION

A Laboratory Information Management System (LIMS) can be used to manage laboratory workflows, e.g., to track batches of samples for clinical testing as the batches move through various processing stages. Tools, such as bar code scanners, may be employed by the LIMS to track the batches as the batches progress within the respective workflows, and a user can view status of the batches, typically in tabular form, on a display provided by the LIMS.

### SUMMARY OF THE INVENTION

A method and system of visually displaying a workflow according to an example embodiment of the present invention includes visually arranging graphical representations of batches within a workflow to indicate workloads at multiple tasks within the workflow to form a visual arrangement. The graphical representations can have a graphical feature indicating relative workloads to process the batches at the respective tasks. The method further includes updating the visual arrangement of the representations of batches as batches progress within the workflow.

The graphical feature may include at least one of color, size, shape, height, and width to indicate an attribute of the batches. For example, the graphical feature can include color, and the attribute can be batch type, batch age, batch urgency, batch priority, or number of units per batch. Alternatively or in addition, the graphical feature can be shape, and the width or length of the shape can be indicative of batch type, batch age, batch urgency, batch priority, or number of units per batch.

The workflow may include at least one of a serial, parallel, divergent, and convergent workflow. For example, the workflow can include a parallel workflow having parallel tasks, and visually arranging the graphical representations of batches can include displaying the parallel tasks on separate lines of the visual arrangement.

Alternatively or in addition, the workflow can include a serial workflow having serial tasks, and visually arranging the graphical representations of batches can include displaying the representations in an ordered manner along an axis of the visual arrangement according to the order of the serial tasks. The workflow may include at least one of a clinical laboratory workflow, manufacturing workflow, food processing workflow, quality control workflow, transportation workflow, or logistical workflow.

Furthermore, visually arranging the graphical representations of batches can include vertically stacking the representations along discrete points of a horizontal axis of the visual arrangement to indicate the quantity of batches at each task in the workflow. Further, visually arranging the graphical representations of batches can include displaying batches according to the tasks, wherein the tasks are grouped. For example, the tasks can include subtasks, and the tasks may be grouped according to the subtasks. The tasks may be geographically separated. Visually arranging graphical representations of batches can also include displaying a reference line for one or more of the tasks to indicate a target number of batches at the one or more tasks.

Updating the visual arrangement can include enabling selection of task and batch type to update the visual arrangement on a per task basis or per workflow basis, highlighting or deemphasizing at least one of the graphical representations, updating the representations of batches in real time, or combinations thereof. Further, updating the visual arrangement of the representations of batches may include displaying representations of batches that have been completed within a fixed time period to monitor cadence in the workflow.

The method of visually displaying the workflow may further include selectively re-batching in response to a user's graphical interaction with the representations of batches.

The relative workloads can include at least one of time and resources. Each of the batches can include one or more individual units, and the graphical feature of the graphical representation of each batch can be a function of an attribute of the one or more individual units. For example, the attribute may include at least one of type and quantity.

The batches can be batches of real-world articles or services, such as laboratory samples, cargo, food items, and industrial products. Each batch can include one or more units, e.g., one or more laboratory samples. An adjustment, modification or change of the representations of batches, e.g., through re-batching, can cause a user or machine to change a state of the real-world articles or services. The adjustment can be in response to the user's interaction with the representations.

The method of visually displaying the workflow can further include visually representing transport of batches between tasks within the workflow. For example, batches of laboratory samples may be transported from one task to another task, one room to another room, or one building to another, as the batches move within the workflow. Transport may include any kind of transport, such as carrying, shipping, or moving, and may include wait time before, during, or after transport, e.g., wait time at a task within the workflow.

In some embodiments, visually arranging the graphical representations of batches includes displaying a multi-colored vertical gauge overlaid on the graphical representations for one or more of the tasks to indicate whether the current workload at the one or more tasks is within one or more user-definable ranges. The method of visually displaying a workflow may further include converting a metric of workload based on an attribute of the batches to an alternate metric of workload corresponding to a task downstream from the workflow. The graphical representations can further include a graphical feature based on the alternate metric indicating relative workloads to process the batches at the downstream task. The method may further include estimating completion time for one or more batches within the workflow as a function of actual progression of the batches within the workflow. Further, the method may include enabling user selection of a pull-based visual arrangement or a push-based visual arrangement.

The method of visually displaying a workflow can be computer implemented. For example, elements or procedures of the method can be performed by a processor. The processor can have access to memory storing data relating to the workflow. In an embodiment, the processor and memory are operatively connected in a network. The processor can be configured to visually arrange graphical representations of batches within the workflow according to the method described herein and to update the visual arrangement of the presentations of batch as batches progress within the workflow. The visual arrangement may be displayed on a display unit operatively coupled to the processor.

A computer program product according to an example embodiment includes a non-transitory computer readable medium having computer-executable instructions stored thereon, which, when loaded and executed by a processor, cause the processor to visually arrange graphical representations of batches within a workflow to indicate workloads at multiple tasks within the workflow to form a visual arrangement, the graphical representations having a graphical feature indicating relative workloads to process the batches at the respective tasks; and update the visual arrangement of the representations of batches as batches progress within the workflow.

Embodiments of the present invention have many advantages. For example, embodiments use graphical representations of variable size, shape, and color to represent batches, e.g., batches of laboratory samples, moving through a complex workflow. An advantage of the current approach of visually displaying a workflow over previous approaches is that showing all data simultaneously and using shapes and sizes to represent variable batch sizes can provide users, e.g., laboratory managers, with a better indication of how many samples there are at each stage in a process or workflow. The current approach provides the user with a more intuitive feeling of the workload, e.g., the number of samples, at each stage or task in a workflow. This has the benefit that the user can more easily identify bottlenecks in the workflow. Furthermore, embodiments provide the user with ability to selectively re-batch by interacting with the graphical representations of batches. Adjusting the graphical representations, e.g. through re-batching, can trigger adjustments to real-world articles or services represented by the graphical representations.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a schematic diagram illustrating a multi-task workflow;

FIG. 1B is a schematic diagram illustrating batches arranged on a multi-task workflow;

FIG. 1C illustrates a laboratory sample plate and a laboratory sample rack representing example batches in a clinical laboratory workflow;

FIG. 1D illustrates shipping containers in a cargo terminal representing example batches in a logistical workflow;

FIG. 2A is a diagram of a visual arrangement of representations of batches illustrating graphical visualization of batch status according to an example embodiment of the present invention;

FIG. 2B is an expanded view of the graphical visualization of a task of FIG. 2A;

FIG. 3 is a diagram illustrating an example visual arrangement of representations of batches including batches in a workflow selected by age;

FIG. 4 is a diagram illustrating an example visual arrangement of representations of batches in concurrent workflows;

FIG. 5 is a diagram illustrating example visual arrangements of representations of batches at three different days showing batch progress; and

FIG. 6A is a diagram illustrating an example visual arrangement of representations of batches in multiple laboratory workflows including a pull-based visualization of workload;

FIG. 6B illustrates pull boxes in a laboratory environment;

FIG. 7 is a diagram illustrating an example visual arrangement of representations of batches including use of an alternate metric for determining workload;

FIG. 8 is a diagram illustrating another example visual arrangement of representations of batches in a workflow;

FIG. 9 is a diagram illustrating yet another example visual arrangement of representations of batches in a workflow;

FIG. 10 is a network diagram illustrating an example computer network or similar digital processing environment in which an embodiment of the present invention may be implemented;

FIG. 11 is a diagram of an example internal structure of a computer in the example computer network of FIG. 10, in accordance with an embodiment of the invention.

### DETAILED DESCRIPTION OF THE INVENTION

A description of example embodiments of the invention follows.

Batches of work move through ordered, multi-task workflows that may be parallel, serial, divergent or convergent depending on batch type, processing results, or other conditions. Tasks may not be physically arranged in a way that permits physical observation of workload (e.g., the number of batches) at the tasks or see the workflow as a whole. A database or other source can provide batch type, size, task, and other attributes which are converted to computer graphics using color to indicate type or other attributes and size and shape to indicate batch size. These graphical representations can be arranged in groups to indicate workload and ordered to indicate workflow. Each task can have a target batch count to keep the flow of batches steady from task to task. This visual arrangement can be used to visually re-batch, anticipate or react to backlogs and bottlenecks, and monitor throughput.

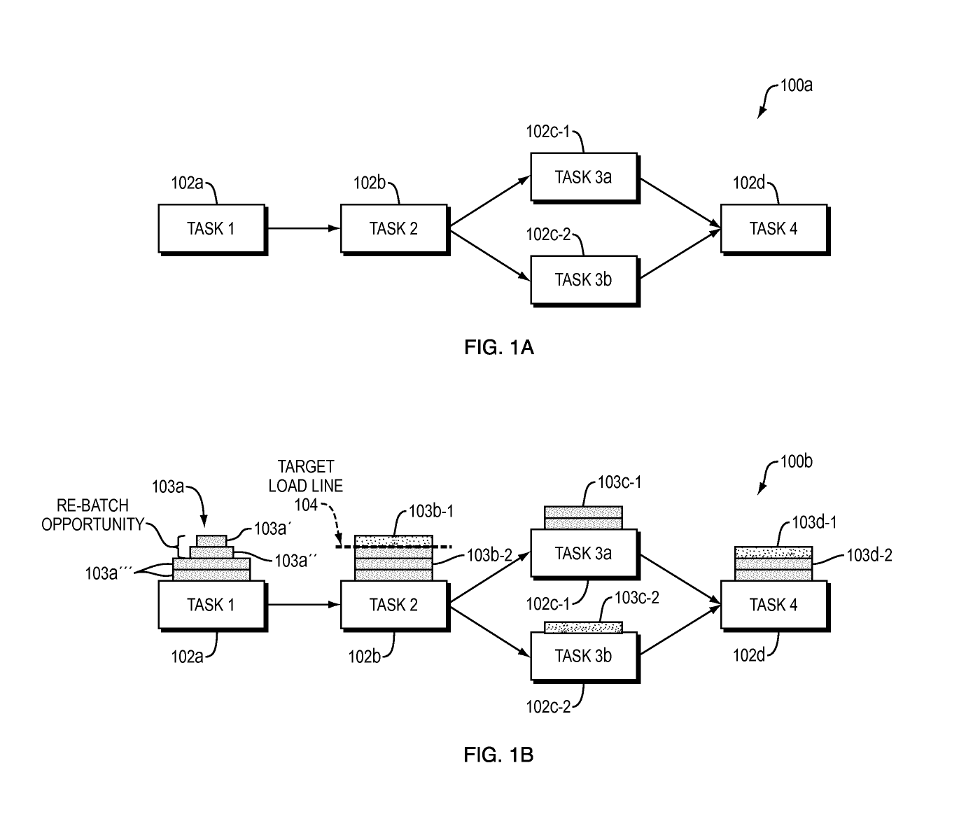

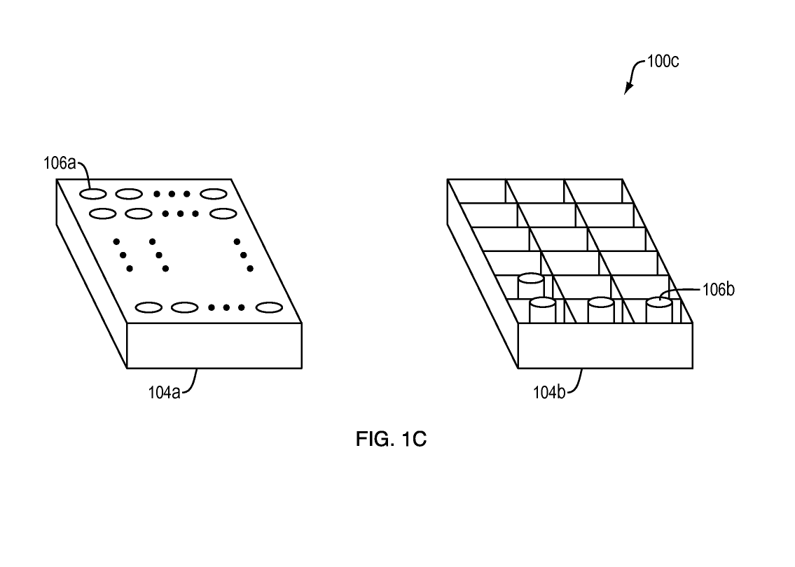

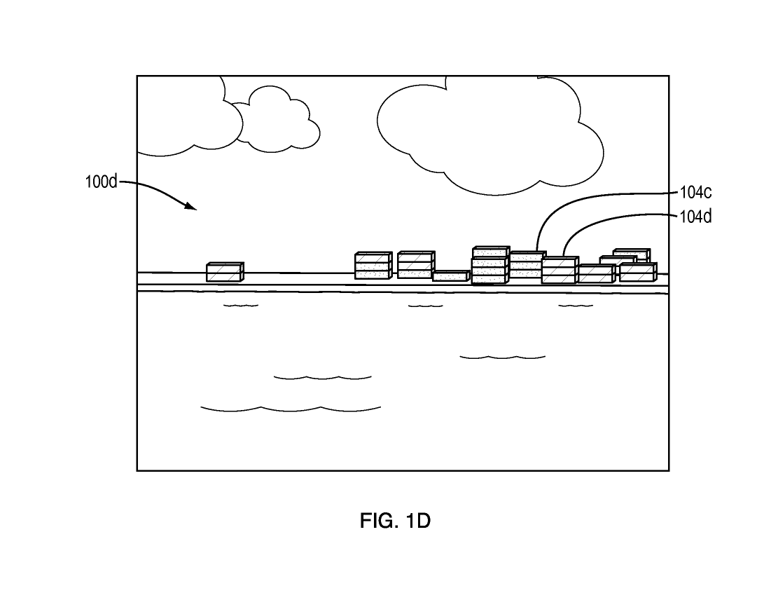

FIG. 1A is a schematic diagram illustrating a multi-task workflow 100a. In the multi-task workflow 100a, each task represents a prescribed set of actions performed by a bounded set of resources, e.g., equipment or personnel, which limits the maximum workload that can be handled in a given time. As shown, the multi-task workflow 100a includes tasks 102a, 102b, 102c-1, 102c-2, and 102d, which are arranged in four stages or steps (Task 1 through Task 4). Tasks 1 and 2 (102a and 102b) are serial tasks, meaning that all batches in the workflow move first through Task 1 (102a) and then through Task 2 (102b). Tasks 3a (102c-1) and 3b (102c-2) are divergent tasks, meaning that some batches move through task 102c-1 while others move through task 102c-2. Tasks 3a (102c-1) and 3b (102c-2) represent a split in the workflow depending on the work type. After having moved through task 102c-1 or task 102c-2, the batches converge on Task 4 (102d), which is referred to as a convergent task.

FIG. 1B is a schematic diagram illustrating batches arranged on a multi-task workflow 100b that is similar to the workflow 100a of FIG. 1A. The relative workload(s) to process the batches at respective tasks can be quantified, and graphically represented, by the number of batches at a given task. As shown, each batch is represented by a rectangle, which are vertically stacked at each task (see group of batches 103a, including batches 103a′, 103a″, and 103a′″ at task 102a). The relative workload(s) can be further specified by an attribute of the batch, such as batch size (shown by size of the graphical representation of the batch, e.g., width of each rectangle representing batch 103a′) and batch type (shown by color of the graphical representation, e.g., compare the color of the rectangles representing respective batches 103b-1, 103c-2 and 103d-1 with that of the rectangles representing batches 103b-2, 103c-1 and 103d-2). Note that in FIG. 1B and subsequent figures, color of a graphical representations is illustrated by a fill pattern, e.g., stippling of hatching. Smaller batches, e.g., batches 103a′ and 103a″, at the same task e.g., task 102a, can be identified for re-batching into a single larger batch, e.g., 103a′″, to reduce work overhead at subsequent tasks due to efficiencies of scale. This visual re-batching also allows smaller batches at separate but nearby tasks to be identified and held for consolidation. Thus, modification of the graphical representation(s), e.g., through re-batching, can result in modification of the represented real world articles or services.

As shown in FIG. 1B, a visual target load line 104 can be set and shown for any task in the workflow as in indicator of when the workload at that task has exceeded a target workload, for example, of what can be done in an allotted time as required to keep up with the cadence of the overall workflow. In the example shown, there are three batches of one type (103b-2) and one batch of another type (103b-1) at task 102b. The total of four batches at task 102b exceeds the target load line 104 by one batch. This can be an alert to both the local and supervisory resources that there may be a problem causing a slowdown at that task or an unusual workload due to external circumstances that may warrant additional resources, such as personnel or equipment to relieve any backlog or bottleneck. The target load line can also be used to optimize the normal amount of resources that should devoted to each task as part of the line balancing process.

FIGS. 1C and 1D illustrate examples of batches of real-world articles. FIG. 1C illustrates a laboratory sample plate and a laboratory sample rack representing example batches in a clinical laboratory workflow 100c. The figure shows tubes of lab samples 106b arrayed in a rack 104b as a batch. Other arrangements may include samples arrayed in fixed wells 106a on rectangular plates 104a. In general, there can be a variable number of samples in any given batch while the maximum batch sizes (i.e., the maximum number of samples per batch) may be fixed due to logistical constraints, such as the size and/or configuration of sample plates or transport containers.

Batches, such as those depicted in FIG. 1C, can move through the workflow as single units optimized for the work to be performed at each task or step in the workflow, i.e., the robotic liquid handling machines in a clinical laboratory are designed to work with the sample plates at high speed. In other embodiments, the samples can be packages loaded into shipping containers going through an outbound inspection and weighing workflow with fixed throughput at each task.

FIG. 1D illustrates shipping containers in a cargo terminal representing example batches 104c and 104d in a logistical workflow 100d. This physical manifestation of workload stacked at various locations along the cargo terminal motivates a similar approach for visually arranging graphical representations of batches within a workflow, as shown and described herein, as human visual perception allows parallel processing and comparison of multiple features of a scene while cognitive processing of numbers or text is serial and much slower.

Additional inspiration for visually displaying workflow according to the principles of the present invention comes from the layout of factories and manufacturing lines. Keeping subsequent tasks proximate to each other allows workers to see what is coming next and whether there is downstream trouble. Arranging all the tasks in a single large building allows the entire process to be envisioned at once so a supervisor from a birds-eye view can spot actual or possible trouble. Most actual workflows, whether physical or intellectual, are not arranged in this idealized manufacturing setup, which prevents personnel from seeing and reacting to upstream and downstream workload and prevents supervisors from seeing the whole process. The embodiments described herein take such disparate tasks and allows the workflow to be envisioned as a whole.

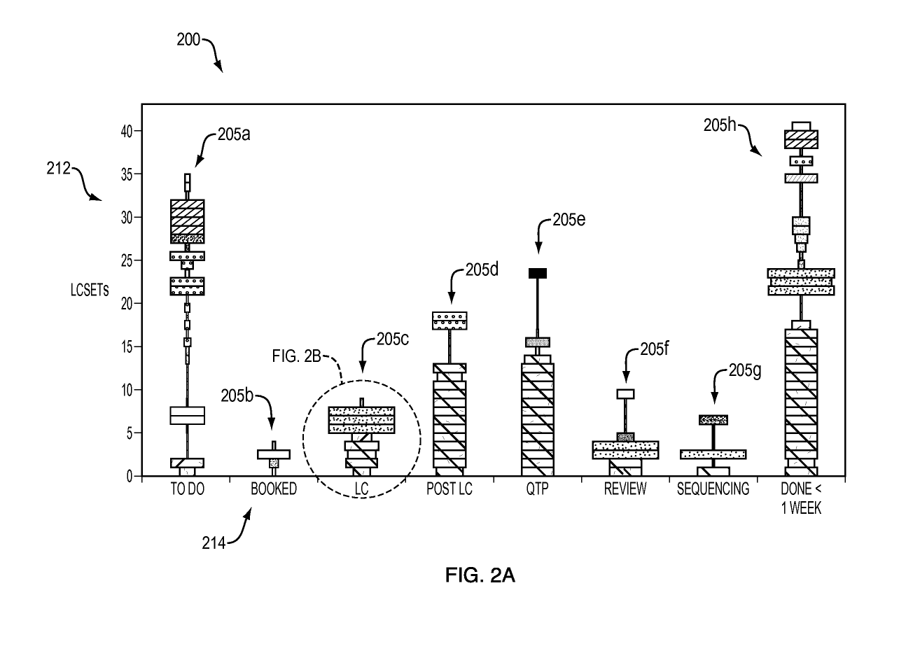

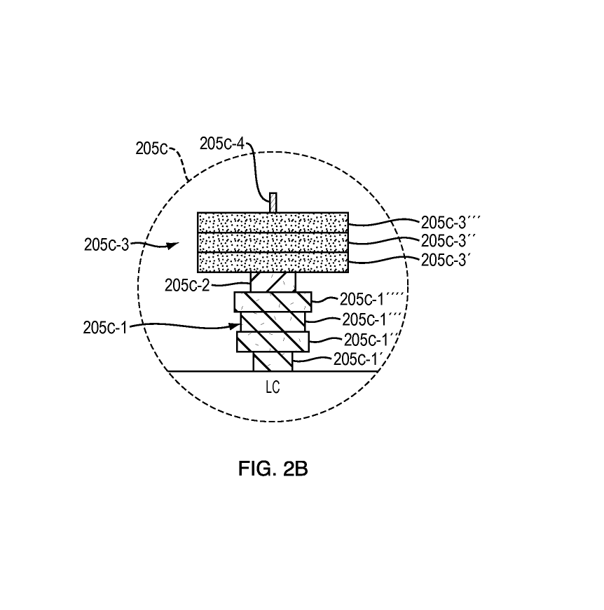

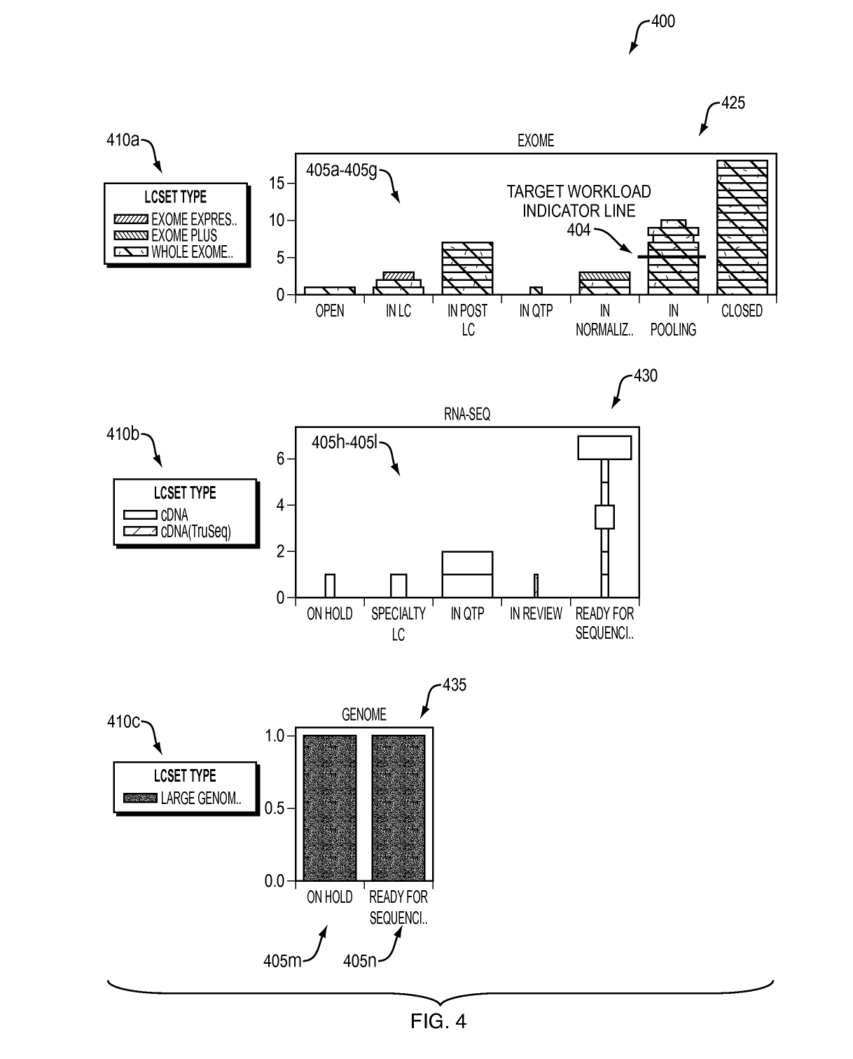

FIG. 2A is a diagram of a visual arrangement 200 of representations of batches illustrating graphical visualization of batch status according to an example embodiment of the present invention. In this example, batches of lab samples known as Library Construction Sets (LCSETs) are depicted at multiple tasks within the workflow moving from left to right along a horizontal axis 214 of the visual arrangement. The vertical axis or scale 212 shows the count of batches. The example illustrates visually arranging the graphical representations of batches by vertically stacking the representations along discrete points of horizontal axis 214 of the visual arrangement 200 to indicate the quantity of batches at each task in the workflow. In this case, the tasks are “To Do” (205a), representing those that need to be scheduled; “Booked” (205b), indicating those that have been assigned a start date; “LC” (205c), indicating Library Construction (LC), the first physical work step in this workflow; “Post LC” (205d) indicating steps taken after LC to prepare the samples for the testing task; “QTP” (205e) quantification, template loading, and pooling, indicating quality control and normalization steps, further described in reference to FIG. 4, followed by “Review” (205f) and “Sequencing” (205g). An additional column “Done <1 week” (205h) is shown as a current measure of recently completed work, i.e., current throughput.

FIG. 2B is an expanded view of the graphical visualization of a task of FIG. 2A. The close-up of batches at the “LC” task (205c) shows 9 batches of 4 types (205c-1′, 205c-1″, 205c-1′″, and 205c-1″″, collectively 205c-1; 205c-2; 205c-3′, 205c-3″, and 205c-3′″, collectively 205c-3; and 205-c4) with varying sizes. The graphical representations of batches have one or more graphical feature indicating relative workloads to process the batches at the respective tasks. As shown, the graphical features are size, e.g., number of samples per batch, shown as width of the rectangle representing a batch, and color (illustrated using different fill patterns), representing the batch type.

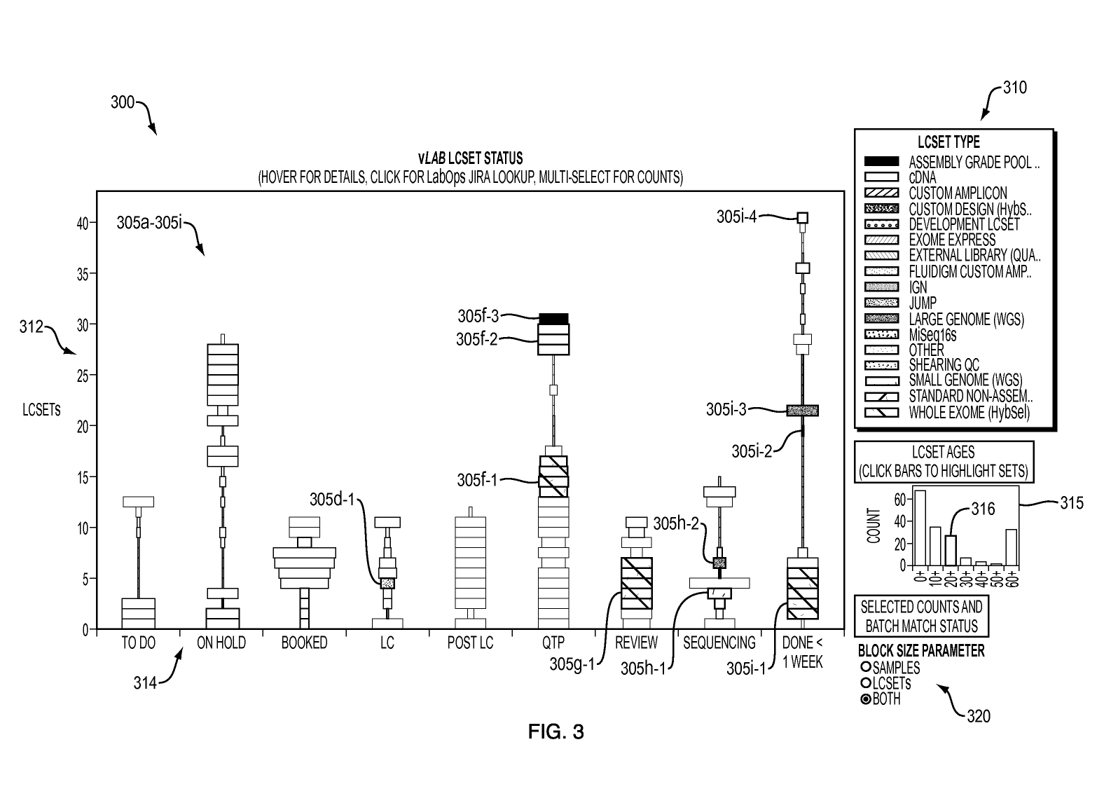

FIG. 3 is a diagram illustrating an example visual arrangement 300 of representations of batches including batches in a workflow selected by age. Batches are arranged in an ordered manner along a horizontal axis 314 by tasks (305a-305i) in the workflow, and the number of batches (LCSETs) at each task is shown on a vertical axis 312, similar to the arrangement 200 of FIG. 2A. A feature of the present approach is the ability to highlight batches by additional criteria, such as how long the batches have been in process. This may indicate batches that may have stalled or be behind a promised delivery date. The histogram 315 shows the number of batches in various age brackets, one of which is selected (316) to highlight those batches of ages 20-30 days, graying out (or otherwise deemphasizing) all other batches for contrast. As shown, the highlighted batches are 305d-1, 305f-1, 305f-2, 305f-3, 305g-1, 305h-1, 305h-2, 305i-1, 305i-2, 305i-3, and 305i-4. Batch types are shown in the color legend 310, which can also be used to highlight batches of certain types. Batch types may be designated based on the type of samples in a batch, such as DNA vs. RNA, or the type of processing that is to be performed, such as exome sequencing vs. genome sequencing, or the priority assigned to the batch, such as express delivery vs. standard delivery.

In the visual arrangement 300 of FIG. 3, an optional parameter 320 controls the graphical representation of the batches, e.g., the batch graphic shape, which in this case is set to show both count (“LCSETs”) and size (Samples) of batches, which may be the standard mode for visually displaying the workflow, as it most closely represents the amount of physical work that must be processed. Further, showing both counts and size of batches allows discrete batches to be more easily discriminated, without the need for textual labels on the batch graphics, which would be illegible at high batch counts and interfere with the visual comprehension of the workload.

FIG. 4 is a diagram illustrating an example visual arrangement 400 of representations of batches in concurrent workflows. Multiple concurrent or parallel workflows 425, 430, 435 are depicted, indicating parallel processing, i.e., no shared resources with the other workflows. The tasks 405a-405g, 405h-405l, and 405m-405n of respective workflows 425, 430, and 435 are parallel tasks. As shown, the visual arrangement 400 of the graphical representations of batches includes the parallel tasks displayed on separate lines of the visual arrangement. Batch types, shown at 410a, 410b, and 410c, differ for each of the workflows.

As shown in FIG. 4, the “Exome” workflow 425 employs a reference line or target workload indicator line 404 to show that the number of batches at the “In Pooling” task 405f is above what can be handled in the normally expected time. This signals to the user that delays are likely without intervention. Task 405a (“Open”) shows batches ready to be started. Task 405b (“In LC”) shows batches in library construction (LC), which splits the input sample into small fragments and attaches adapters needed by the sequencing machines. Task 405c (“In Post LC”) is a selection step, where only fragments from the targeted exome region of the genome are kept. Task 405d (“In QTP”) is a quantification step, where the density of the selected fragments is determined. Task 405e (“In Normalization”) equalizes the density across samples so they can be pooled together in task 405f (“In Pooling”) for loading on the sequencers. Task 405g (“Closed”) is not a work step, but rather a final state that is shown to indicate recently completed work, as a means of assessing throughput. The other two workflows 430 (“RNA-Seq”) and 435 (“Genome”) are for different batch types but show similar tasks for those lines which are run in parallel with the Exome workflow using separate personnel and equipment.

Several tasks shown in FIG. 4 are subtasks [e.g., 405d (“In QTP”), 405e (“In Normalization”), and 405f (“In Pooling”)] of tasks shown consolidated in FIGS. 2 and 3 (e.g., 205e, 305f), as they break high-level tasks (e.g. “QTP”) into smaller, more specific sub-tasks depending on the batch type (e.g. “In QTP”, “In Normalization,” and “In Pooling”).

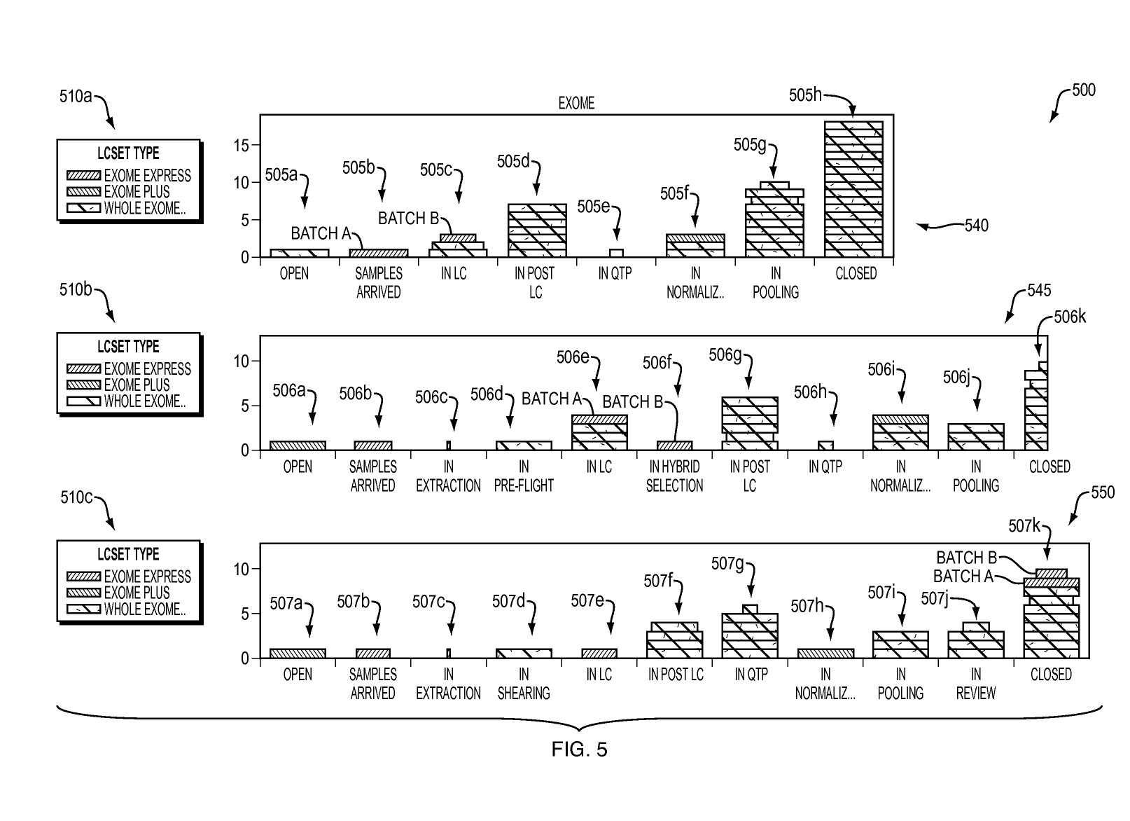

FIG. 5 is a diagram 500 illustrating example visual arrangements 540, 545, and 550 of representations of batches at three different days showing batch progress. The figure shows an actual workflow progressing over several days. The visual arrangement of the representations of batches is updated as batches progress within the workflow. In the example, the visual arrangement 540 is updated to visual arrangement 545, which is updated to visual arrangement 550, as batches progress over several days. In this example, batches are tracked over five days, i.e., at days 1, 3, and 5. In each of the visual arrangements, three types of batches (LCSET Types) are tracked as indicated at 510a, 510b, and 510c: “Exome Express,” Exome Plus,” and “Whole Exome (HybSel).” Two of the “Exome Express” batches are labeled Batch A and Batch B in each of the visual arrangements 540, 545, and 550. The three types of batches move through the same workflow but with differences in priority and recipe at some of the tasks or steps. For example, batches of type “Exome Express” receive expedited handling, while batches of type “Exome Plus” receive a larger bait set at the “HybridSelection” step in order to capture more of the genome. The displayed tasks in visual arrangements 540, 545, and 550 are 505a-505h, 506a-506k and 507a-507k, respectively. The displayed tasks can dynamically update to only show tasks where one or more batches are currently present. For example, visual arrangement 545 shows a batch at task 506c (“In Extraction”), which is a task where the DNA is extracted from a blood or tissue sample. However, visual arrangement 540, which is a snapshot of the workflow from an earlier day, does not display such a task. Visual arrangement 545 also shows a batch, i.e., Batch B, at task 506f (“In Hybrid Selection”), which is a task where specific regions of the genome are isolated for sequencing and the rest of the DNA is discarded. Again, visual arrangement 540 does not display such a task. Further, visual arrangement 550 shows a batch at task 507d (“In Shearing”), which is a task where the full-length strands of DNA are sheared into small pieces suitable for lab work and sequencing. Neither of visual arrangements 540 and 545 shows such a task.

As illustrated by the example visual arrangements of FIG. 5, embodiments of the invention enable a user to visualize the progression of batches, e.g., Batch A and Batch B, through the tasks of the workflow, and may also help the user to identify any potential bottlenecks, such as if a downstream task is above a specified target load line (see FIG. 4). This allows a user of the system to see where (e.g., at what task in the workflow) any particular batch or batches of interest are and what lies ahead in their respective paths through the workflow. In the example of FIG. 5, progression over several days is shown, but it will be understood that the visual arrangement(s) of the representations of batches may be updated at any time increment, including seconds, minutes, hours, days, and years.

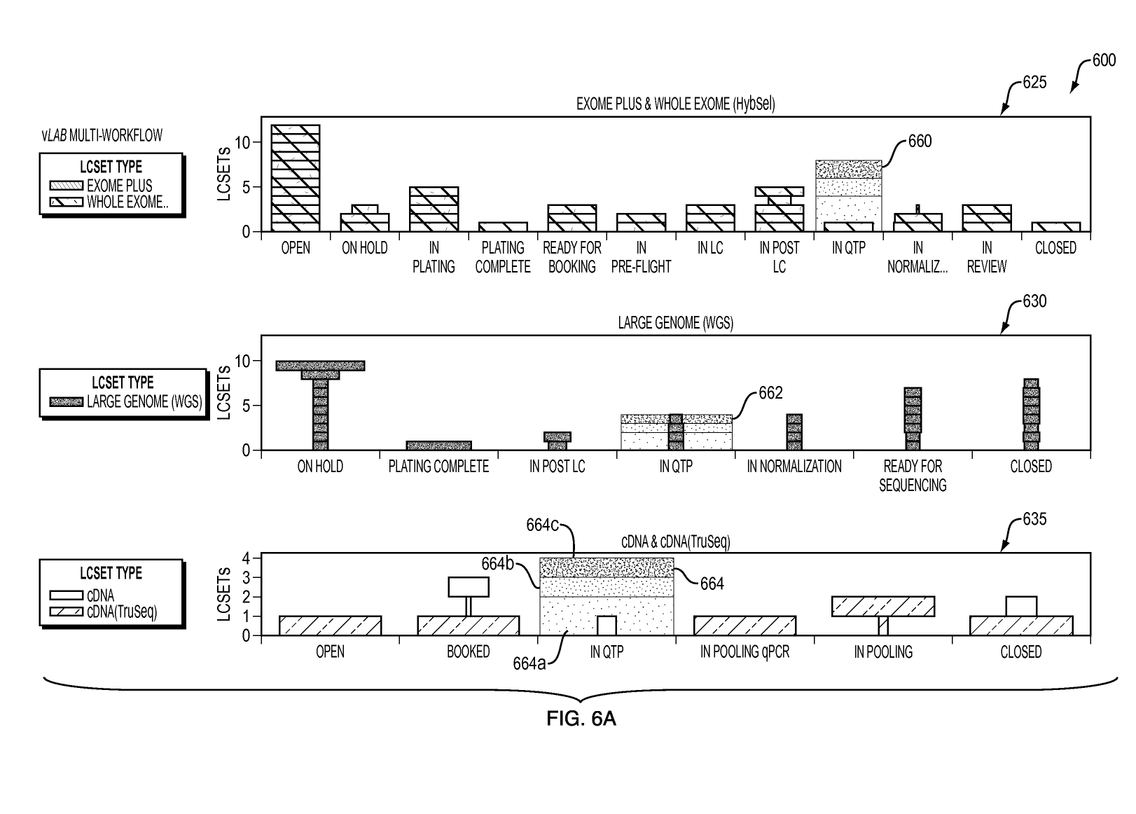

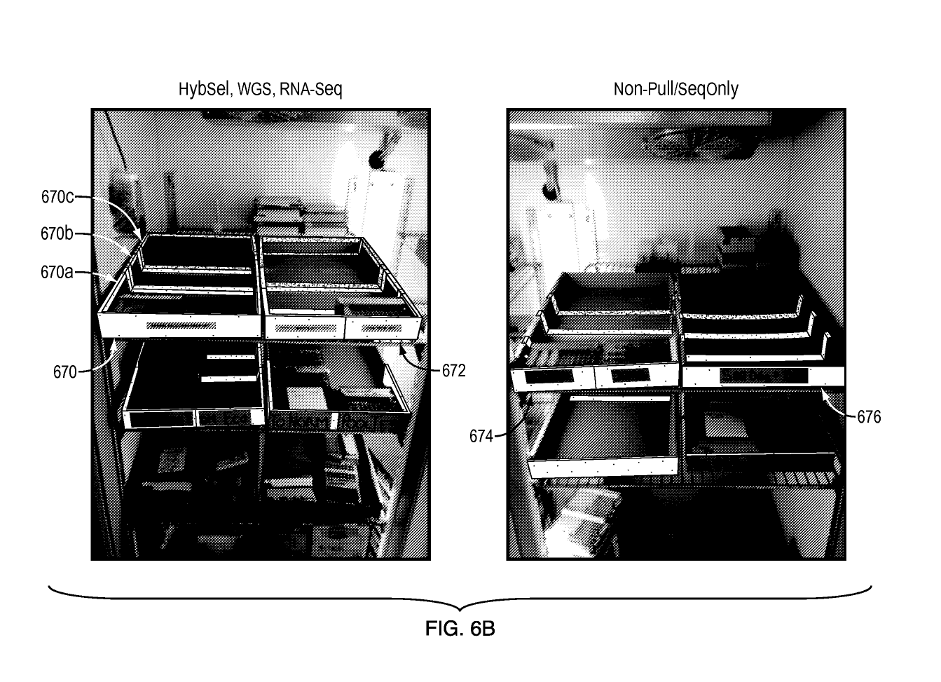

FIG. 6A is a diagram illustrating an example visual arrangement 600 of representations of batches in multiple laboratory workflows 625, 630 and 635. In the example shown, the graphical representations of batches are visually arranged as, for example, described above in reference to the embodiment of FIG. 4. The embodiment of FIG. 6A includes multi-colored vertical gauges 660, 662, and 664 that are displayed overlaid on (or otherwise associated with) the graphical representations for the “In QTP” task in each of the workflows 625, 630, and 635. This feature extends the feature illustrated in FIG. 4 of displaying a reference line for one or more of the tasks, e.g., a reference target workload indicator line 404. The extension of this feature, as illustrated in FIG. 6A, adds a multi-colored vertical gauge to indicate whether the current workload at one or more tasks is within one or more user-definable ranges. Here, ranges are expressed in number of batches (LCSETs). In this embodiment, the ranges or levels are set to mimic the physical pull boxes used at the QTP step in the laboratory process for each batch type.

FIG. 6B illustrates pull boxes 670, 672, 674, 676 in a laboratory environment. As shown, the pull boxes are placed in a refrigerator associated with the QTP task, e.g., a refrigerator at a location where the QTP task is performed. In the physical environment, the colors green (670a), orange (670b), and red (670c) send respective “go,” “slow,” and “no work” signals to one or more upstream processes as part of a lean manufacturing pull system. This feature allows users to see where more or less work is currently needed throughout the workflow. In the example shown in FIG. 6A, the color green (664a) is at the bottom of the vertical gauge 664 because a pull system tells the upstream process(es), or upstream operator(s), what the downstream operators need to keep the downstream operators' queues full. In other words, a downstream operator at a task whose graphical representations are in the green range knows to pull (or request) from an upstream task to fill the downstream operator's own task. Similarly, the downstream operator will know to pull slowly if the graphical representations are in the yellow range (664b), and not to pull if in the red range (664c) to allow the user's workload at the task to be reduced until the graphical representations are again in the yellow or green. Multi-color gauges need not have three colors and colors other than those described herein may be used.

Multi-color gauges may be placed or displayed at one or more tasks in the workflow. For example, multi-color gauges may be placed or displayed at important controllable points in the workflow. In the example shown in FIG. 6A, a multi-color gauge (660, 662, 664) is used at the “In QTP” tasks because that task represents a major milestone or pivot point in the process of workflows 625, 630, and 635. At the QTP task, batches of laboratory samples are held in a refrigerator for processing. Typically, once a batch is taken out of the refrigerator, the batch must be processed down the workflow in a certain amount of time to avoid having the samples in the batch deteriorate in quality. In the example shown in FIG. 6A, a multi-color gauge could have also been placed at the “In Plating” task. In general, a multi-color gauge may be placed at a point in the workflow where tasks in the workflow converge. A multi-color gauge may also be placed where tasks in the workflow diverge. Multi-color gauges can be used to gauge throughput. Advantageously, a multi-color gauge is used at a task where a user, such as a supervisor of the process, has the ability to make adjustments to the workflow. For example, a user may re-prioritize or re-batch batches (e.g., batches of real world articles) in the workload in response to information gleaned from the multi-color gauge. A multi-color gauge at a particular task may be configured from the perspective of somebody working at that task. In a pull-type process, a multi-colored gauge may be configured from the “pull” perspective. In an embodiment, a method of displaying a workflow can include enabling a user to select a pull-based visual arrangement, a push-based visual arrangement, or a combination thereof.

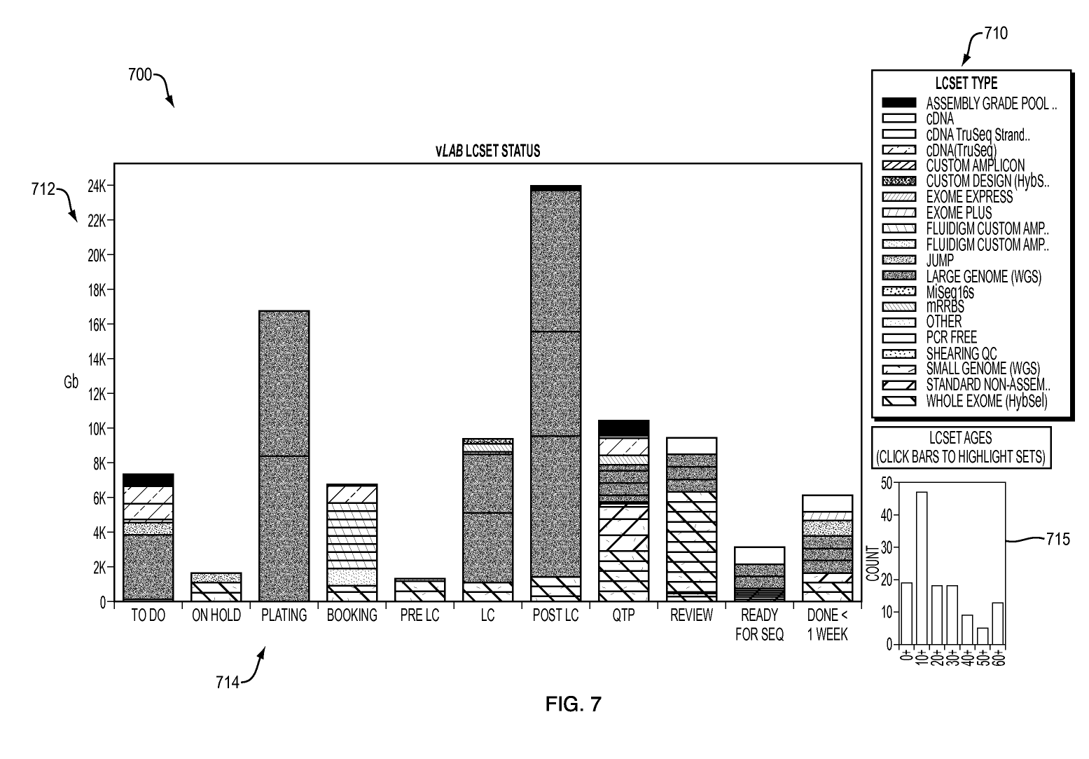

FIG. 7 is a diagram illustrating an example visual arrangement 700 of representations of batches including use of an alternate metric for determining workload. This alternate metric, for example, can be the amount of downstream processing required, such as total number of sequencing runs in a laboratory process. In a logistical workflow, the alternate metric may be the number of containers or trucks that that will be required to ship units of a product. A method of displaying a workflow can include converting a metric of workload based on an attribute of the batches to an alternate metric of workload at or corresponding to a task downstream from the workflow. The graphical representations can include a graphical feature based on the alternate metric indicating relative workloads to process the batches at the downstream task.

FIG. 7 shows a conversion of the DNA sample batches (LCSETs), such as shown in FIG. 6A, into gigabases (Gb) of downstream sequencing required, which are indicated by the height of the rectangles that represent the batches. Gigabases of downstream sequencing can be calculated as a function of the number of samples per batch and the type of sample or batch. The number of gigabases of sequencing may be a constraint on the process workload. Thus, visualizing the total workload using the gigabase metric can aide a user in assessing total work in progress and in predicting future workload. In FIG. 7, batches are arranged in an ordered manner along a horizontal axis 714 by tasks in the workflow, similar to the arrangements 300, 600 of FIGS. 3 and 6, and the number of gigabases (Gb) of downstream sequencing at each task is shown on a vertical axis 712. A feature of the present approach is the ability to highlight batches by additional criteria, such as how long the batches have been in process. This may indicate batches that may have stalled or be behind a promised delivery date. The histogram 715 shows the number of batches in various age brackets. As described in reference to FIG. 3, one or more age brackets can be selected, e.g., through user-input in a graphical user interface, to highlight those batches corresponding to the age bracket(s), graying out all other batches for contrast. Batch types are shown in the color legend 710, which can also be used to highlight batches of certain types. As described above, batch types may be designated based on the type of samples in a batch, such as DNA vs. RNA, or the type of processing that is to be performed, such as exome sequencing vs. genome sequencing, or the priority assigned to the batch, such as express delivery vs. standard delivery.

As described above in reference to FIG. 7, a method of displaying a workflow in a laboratory setting can include changing the metric by which workload is calculated from number of batches and number of samples per batch to gigabases of sequencing. Such a feature is relevant to other workflows, such as logistical workflow. Instead of converting to gigabases for downstream sequencing, one can convert batch numbers or sample numbers per batch to another metric of one or more downstream tasks, such as weight or volume of units, e.g., for downstream loading onto a truck.

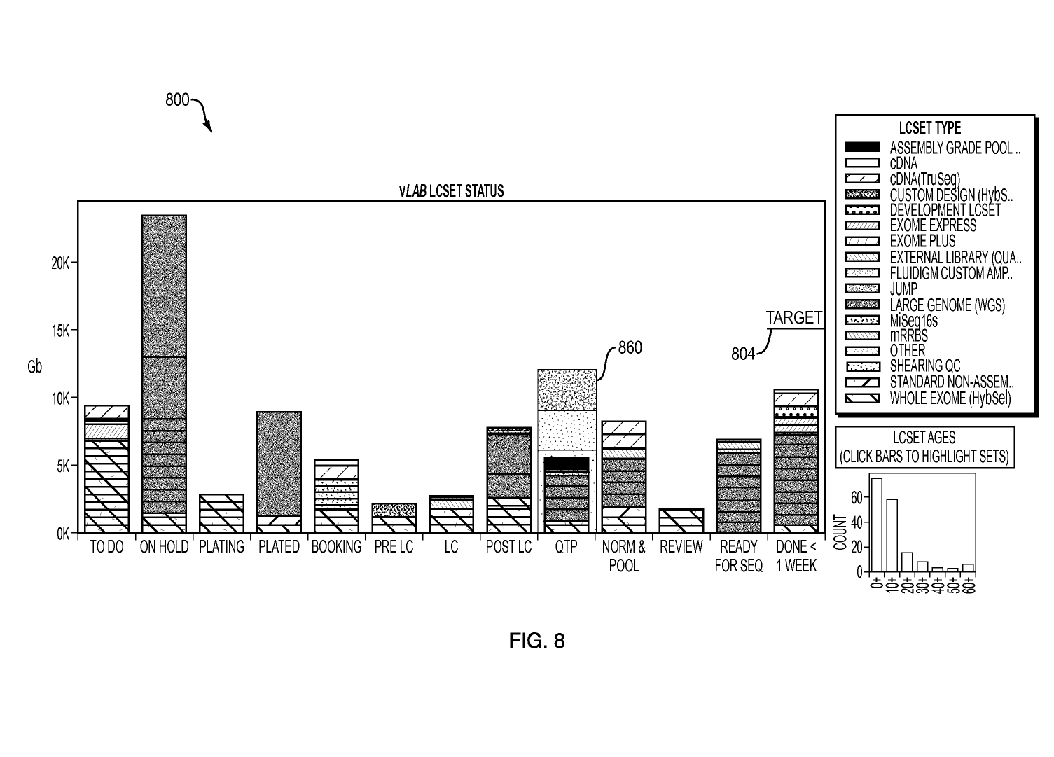

FIG. 8 is a diagram illustrating an example visual arrangement 800 of representations of batches. The figure illustrates a combination of the two concepts described above with reference to FIGS. 6A and 7, whereby one or more target lines and one or more multi-colored gauges can be used to assess the alternate workload metrics. In the embodiment shown in FIG. 8, graphical representations of batches are displayed where a metric associated with an attribute of the batches has been converted to gigabases of downstream sequencing. In addition, a target line 804 based on sequencing capacity is shown. A multi-colored gauge 860 is added to show whether enough work has reached the “QTP” task to be able to keep the gigabases per week on target. The visual arrangement 800 can help a user to assess throughput at the QTP task. For example, the batches may move forward approximately one task per day. On average, a user may want to achieve the target number of gigabases per week, as indicated by target line 804, because downstream sequencing tasks can only handle so many gigabases per week.

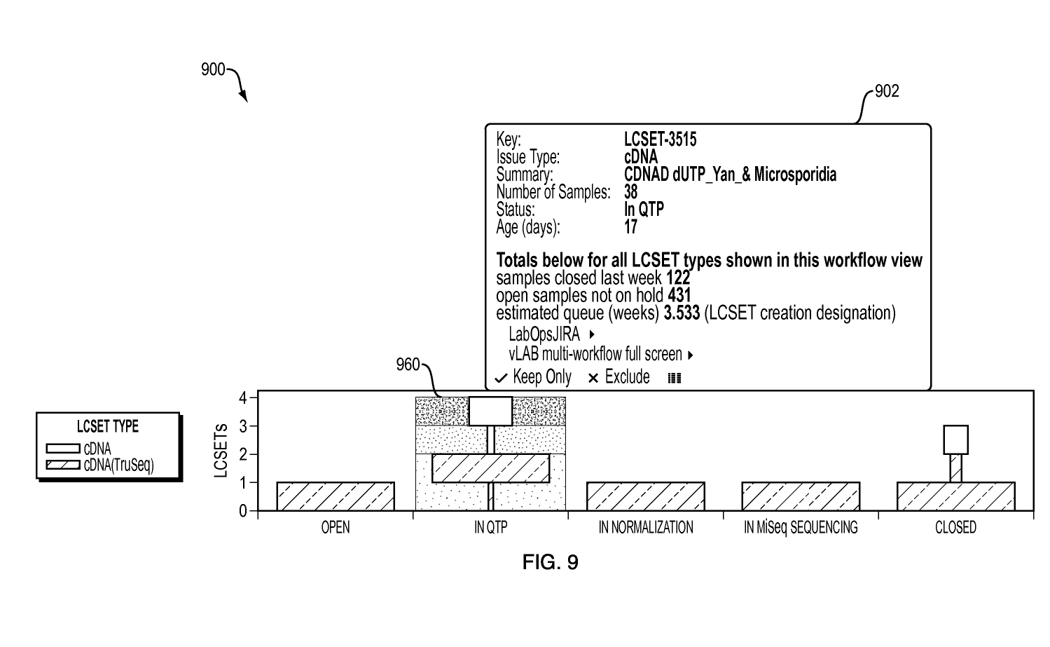

FIG. 9 is a diagram illustrating an example visual arrangement 900 of representations of batches. In an embodiment, a method of visually displaying a workflow includes computing estimated completion times or completion dates for batches within the workflow as a function of actual progression of batches within the workflow. The estimated completion time or date can be based on current real-time throughput by batch type. This feature is similar to a GPS that uses actual speed of travel to estimate arrival time. In the example shown, a batch (“LCSET-3515”) includes 38 samples and is currently at task “In QTP.” The estimated time of completion is 3.533 weeks. Here, the estimated completion time is computed based on the number of samples closed (i.e., samples completed) in the last week, which is indicated to be 122 samples, and the open number of samples in the workflow that are not on hold, which is indicated to be 431 samples. The estimated completion time and other information about a particular batch may be displayed to the user in a pop-up box 902. Also displayed is multi-colored gauge 960, similar to the multi-colored gauges (e.g., 664 and 860) described in reference to FIGS. 6A and 8.

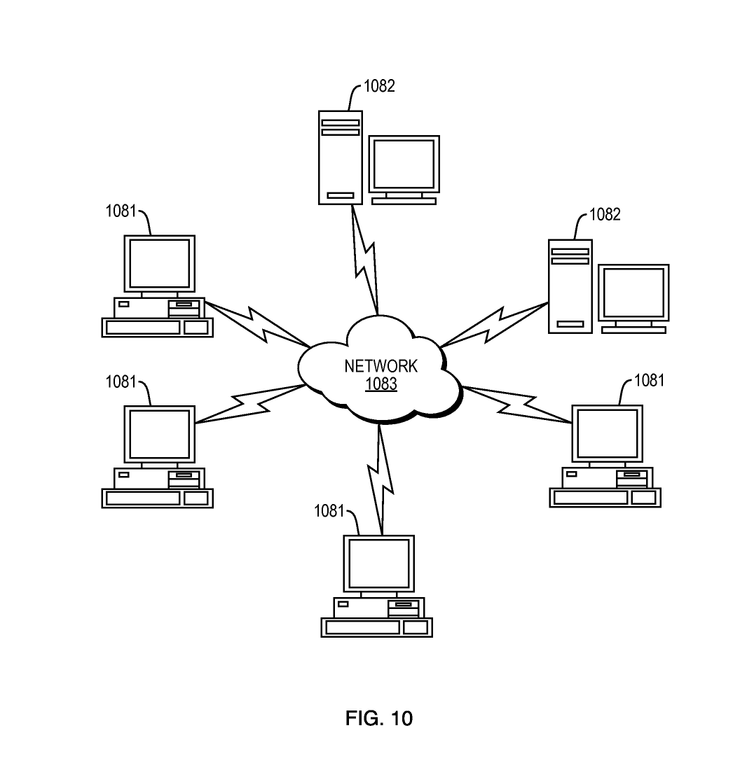

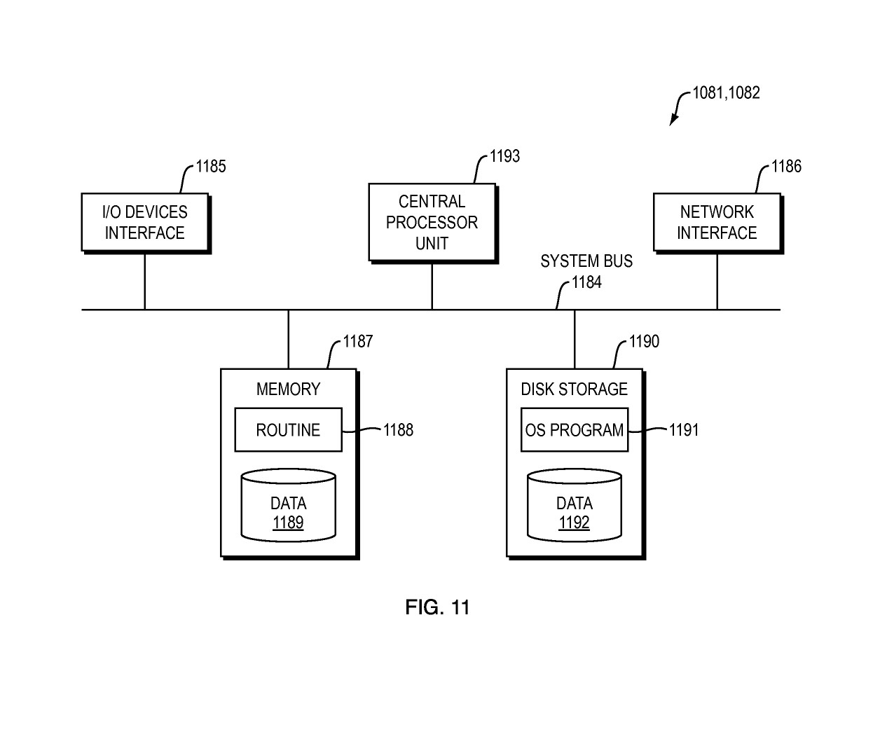

FIG. 10 illustrates a computer network or similar digital processing environment in which an embodiment the present invention may be implemented. Client computer(s)/devices 1081 and server computer(s) 1082 provide processing, storage, and input/output devices executing application programs and the like. Client computers 1081 can include, for example, the computers of users visually displaying a workflow, in accordance with an embodiment of the invention; and server computers 1082 can include one or more systems implementing a method of visually displaying a workflow, in accordance with an embodiment of the invention. Client computer(s)/devices 1081 can also be linked through communications network 1083 to other computing devices, including other client devices/processes 1081 and server computer(s) 1082. Communications network 1083 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

FIG. 11 is a diagram of the internal structure of a computer (e.g., client processor/device 1081 or server computers 1082) in the computer system of FIG. 10, in accordance with an embodiment of the invention. Each computer 1081, 1082 contains system bus 1184, where a bus is a set of hardware lines used for data transfer among the components of a computer or processing system. Bus 1184 is essentially a shared conduit that connects different elements of a computer system (e.g., processor, disk storage, memory, input/output ports, network ports, etc.) that enables the transfer of information between the elements. Attached to system bus 1184 is I/O device interface 1185 for connecting various input and output devices (e.g., keyboard, mouse, displays, printers, speakers, etc.) to the computer 1081, 1082. Network interface 1186 allows the computer to connect to various other devices attached to a network (e.g., network 1083 of FIG. 10). Memory 1187 provides volatile storage for computer software instructions 1188 and data 1189 used to implement an embodiment of the present invention (e.g., routines for visually arranging graphical representations of batches within a workflow and for updating the visual arrangement of the representations of batches as batches progress within the workflow). Disk storage 1190 provides non-volatile storage for computer software instructions 1191 and data 1192 used to implement an embodiment of the present invention. Central processor unit 1193 is also attached to system bus 1184 and provides for the execution of computer instructions.

Portions of the above-described embodiments of the present invention can be implemented using one or more computer systems, for example, to generate and visually arrange graphical representations of batches within a workflow to indicate workloads at multiple tasks within the workflow. For example, the embodiments may be implemented using hardware, software or a combination thereof. When implemented in software, the software code can be stored on any form of non-transient computer-readable medium and loaded and executed on any suitable processor or collection of processors, whether provided in a single computer or distributed among multiple computers.

Further, it should be appreciated that a computer may be embodied in any of a number of forms, such as a rack-mounted computer, desktop computer, laptop computer, or tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, at least a portion of the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

In this respect, it should be appreciated that one implementation of the above-described embodiments comprises at least one computer-readable medium encoded with a computer program (e.g., a plurality of instructions), which, when executed on a processor, performs some or all of the above-described functions of these embodiments. As used herein, the term “computer-readable medium” encompasses only a non-transient computer-readable medium that can be considered to be a machine or a manufacture (i.e., article of manufacture). A computer-readable medium may be, for example, a tangible medium on which computer-readable information may be encoded or stored, a storage medium on which computer-readable information may be encoded or stored, and/or a non-transitory medium on which computer-readable information may be encoded or stored. Other non-exhaustive examples of computer-readable media include a computer memory (e.g., a ROM, RAM, flash memory, or other type of computer memory), magnetic disc or tape, optical disc, and/or other types of computer-readable media that can be considered to be a machine or a manufacture.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims. It should also be appreciated that the various technical features of the embodiments that have been described may be combined in various ways to produce numerous additional embodiments.

1. A system for visually displaying a workflow, the system comprising:
memory configured to store data relating to a workflow; and
a processor having access to the memory and configured to:
visually arrange graphical representations of batches within the workflow to indicate workloads at multiple tasks within the workflow to form a visual arrangement, the graphical representations having a graphical feature indicating relative workloads to process the batches at the respective tasks; and
update the visual arrangement of the representations of batches as batches progress within the workflow.

2. The system according to claim 1, wherein the workflow includes at least one of a serial, parallel, divergent, and convergent workflow.

3. The system according to claim 2, wherein the workflow includes a parallel workflow having parallel tasks, and wherein the processor is configured to visually arrange the graphical representations of batches in a manner that includes displaying the parallel tasks on separate lines of the visual arrangement.

4. The system according to claim 2, wherein the workflow includes a serial workflow having serial tasks, and wherein the processor is configured to visually arrange the graphical representations of batches in a manner that includes displaying the representations in an ordered manner along an axis of the visual arrangement according to the order of the serial tasks.

5. The system according to claim 1, wherein the processor is configured to vertically stack the representations along discrete points of a horizontal axis of the visual arrangement to indicate the quantity of batches at each task in the workflow.

6. (canceled)

7. (canceled)

8. The system according to claim 1, wherein the processor is configured to visually arrange the graphical representations of batches in a manner that includes displaying a reference line for one or more of the tasks to indicate a target number of batches at the one or more tasks.

9. The system according to claim 1, wherein the processor is configured to update the visual arrangement in a manner that enables selection of task and batch type to update the visual arrangement on a per task basis or per workflow basis.

10. The system according to claim 1, wherein the processor is configured to update the visual arrangement in a manner that includes highlighting or deemphasizing at least one of the graphical representations.

11. The system according to claim 1, wherein the processor is configured to update the visual arrangement in a manner that includes updating the representations of batches in real time.

12. The system according to claim 1, wherein the processor is configured to update the visual arrangement in a manner that includes displaying representations of batches that have been completed within a fixed time period to monitor cadence in the workflow.

13. (canceled)

14. The system according to claim 1, wherein the processor is further configured to visually represent transport of batches between the tasks.

15. The system according to claim 1, further including a display unit coupled to the processor and configured to display a multi-colored vertical gauge overlaid on the graphical representations for one or more of the tasks to indicate whether the current workload at the one or more tasks is within one or more user-definable ranges.

16. The system according to claim 1, wherein the processor is further configured to convert a metric of workload based on an attribute of the batches to an alternate metric of workload corresponding to a task downstream from the workflow, and wherein the graphical representations further include a graphical feature based on the alternate metric indicating relative workloads to process the batches at the downstream task.

17. The system according to claim 1, wherein the processor is further configured to estimate completion time for one or more batches within the workflow as a function of actual progression of the batches within the workflow.

18. The system according to claim 1, wherein the processor is further configured to enable user selection of a pull-based visual arrangement or a push-based visual arrangement.

19. (canceled)

20. (canceled)

21. A computer-implemented method of visually displaying a workflow, the method comprising:
by a processor,
visually arranging graphical representations of batches within a workflow to indicate workloads at multiple tasks within the workflow to form a visual arrangement, the graphical representations having a graphical feature indicating relative workloads to process the batches at the respective tasks; and
updating the visual arrangement of the representations of batches as batches progress within the workflow.

22.-44. (canceled)

45. The system according to claim 1, wherein the relative workloads include at least one of time and resources.

46.-48. (canceled)

49. The system according to claim 1, wherein the batches are batches of real-world articles or services, and wherein an adjustment of the representations of batches causes a user or machine to change a state of the real-world articles or services.

50. The system or computer-implemented method according to claim 49, wherein the adjustment is responsive to the user's interaction with the representations.

51. (canceled)

52. A computer program product including a non-transitory computer readable medium having computer-executable instructions stored thereon, which, when loaded and executed by a processor, cause the processor to:
visually arrange graphical representations of batches within a workflow to indicate workloads at multiple tasks within the workflow to form a visual arrangement, the graphical representations having a graphical feature indicating relative workloads to process the batches at the respective tasks; and
update the visual arrangement of the representations of batches as batches progress within the workflow.
